(19) United States
(12) Patent Application Publication
(10) Pub. No.: US 2023/0091633 A1
(43) Pub. Date: Mar. 23, 2023

(54) HUB

(71) Applicant: DT SWISS INC., Grand Junction, CO (US)

(72) Inventors: Martin WALTHERT, Aarberg (CH); Stefan SPAHR, Lengnau (CH)

(21) Appl. No.: 18/053,714

(22) Filed: Nov. 8, 2022

Related U.S. Application Data
(63) Continuation-in-part of application No. 16/256,095, filed on Jan. 24, 2019, now abandoned.

(30) Foreign Application Priority Data
Jan. 25, 2018 (DE) 102018101725.1

(51) Int. Cl. B60B 27/04; B60B 27/02; F16D 41/24

(52) U.S. Cl. CPC B60B 27/047; B60B 27/023; F16D 41/24; B60B 2360/10; B60B 2360/102; B60B 2360/341; B60B 2900/111; B60B 2900/311

(57) ABSTRACT

A hub for bicycles comprising a hub axle, a hub shell, a rotor, and a toothed disk freewheel including a pair of interacting freewheel components namely, a hub-side freewheel component and a rotor-side freewheel component. The freewheel components each comprise axial engagement components biased in the engagement position through a biasing device. The hub-side freewheel component is axially displaceably received in a threaded ring and non-rotatably coupled with the hub shell in the driving direction. The rotor-side freewheel component is non-rotatably provided at the rotor for transmitting rotational movement from the rotor to the hub shell in the engagement position of the two freewheel components. The threaded ring comprises a thread with a thread groove that extends along a helical line in an axial direction around a circumference of the threaded ring, where the helical line shows less than five full revolutions around the circumference of the threaded ring. The thread is screw-connected with a thread of the hub shell.

### CROSS-REFERENCE TO RELATED APPLICATIONS

This application is a continuation-in-part application of and claims priority to U.S. Pat. Application No. 16/256,095 filed on Jan. 24, 2019, which is hereby incorporated by reference in its entirety.

### FIELD OF THE INVENTION

The present invention relates to a hub for at least partially muscle-powered vehicles, and in particular two-wheeled vehicles and preferably bicycles, the hub comprising a hub shell which is rotatably supported relative to a hub axle in particular by way of two roller bearings disposed on opposite end regions of the hub shell. The hub comprises a rotor for non-rotatable arrangement of at least one sprocket, the rotor being in particular rotatably supported relative to the hub axle by means of at least two rotor bearings. A freewheel is provided between the rotor and the hub shell.

### BACKGROUND

Other than in bicycles, a hub may be used in other partially muscle-powered vehicles and two-wheeled vehicles which are for example provided with an electric auxiliary drive. The hub is in particular used in sports bicycles. In all the configurations, the hub according to the invention is employed in vehicles and in particular bicycles which in normal and regular proper use are at least partially muscle-powered.

Hubs for bicycles are exposed to high and highest loads in particular in the field of sports and in semi-professional and also professional uses. A general problem with the freewheels of bicycle hubs is to ensure the function with a wide variety of rotational speeds. Proper functioning must be ensured both in very low speeds and in very high speeds.

Furthermore the freewheel of a bicycle hub must be able to reliably transmit rotational forces as high as those occurring in sports cars. The surface pressures occurring in bicycles may even be higher still since smaller dimensions are involved.

When applying driving force the freewheel must very quickly and reliably establish force closure while on the other hand the freewheel is expected to only show minor friction in back-pedaling or non-pedaling. When riding uphill or e.g. when high acceleration is involved, high dynamic loads act on the hub such that each of the components of the hub and the hub on the whole must be regarded in terms of dynamics. For example in the case of high loads the axle may bend even if the axle is configured as rigid as possible by means of structural measures and the materials employed.

In the prior art different freewheels have been disclosed. A rear wheel hub offering ease of handling in mounting and maintenance has become known in DE 198 47 673 A1. In this hub, torque is transmitted through a pair of toothed disks provided with axial, meshing toothing at their adjacent side faces. The torque applied is reliably transmitted in the driving direction while in the opposite rotational direction the toothed disks axially diverge from one another, thus allowing freewheeling. One of the toothed disks is axially displaceably accommodated in the rotor and the other of the toothed disks, axially displaceably in the hub shell. Since the hub shell tends to consist of a light metal, a narrow, threaded ring of steel with a single thread for fastening is screwed into the hub shell in which the toothed disk is axially displaceably guided. This protects the hub shell from direct contact with the toothed disk. It is a drawback though that the loads generated during pedaling drive the narrow threaded ring permanently into the hub shell. This subjects the hub shell to locally high loads so that the hub shell may dilate and even burst in the region of the threaded ring. To prevent this the wall thickness of the hub shell is made large enough such that the generated loads can be reliably dissipated, which considerably adds to the total weight of the hub.

### SUMMARY

It is therefore the object of the present invention to provide a hub which is in particular lighter in weight and stiffer and which provides for structurally minor or minute deformation in operation.

This object is solved by a hub having the features of claim 1. Preferred specific embodiments of the invention are the subjects of the subclaims. Further advantages and features of the present invention can be taken from the general description and the description of the exemplary embodiments.

A bicycle component according to the invention is provided for at least partially muscle-powered vehicles and in particular two-wheeled vehicles and preferably bicycles and comprises a hub axle and a hub shell, a rotor and a freewheel, the freewheel having two interacting freewheel components namely, a hub-side freewheel component and a rotor-side freewheel component. The two freewheel components each comprise axial engagement components for intermeshing with one another and are biased in the engagement position via a biasing device. The two freewheel components are movable relative to one another in the axial direction at least between a freewheel position and the intermeshing engagement position. The hub-side freewheel component is axially displaceably accommodated in a threaded ring through which it is non-rotatably coupled with the hub shell. The rotor-side freewheel component is provided non-rotatably at the rotor to transmit rotational movement from the rotor to the hub shell in the engagement position of the two freewheel components. The threaded ring comprises at least one thread groove, which extends along a helical line on an inner surface of the threaded ring and around the circumference of the threaded ring. The helical line of the thread groove shows less than five full revolutions around the circumference of the threaded ring. The thread of the threaded ring is screw-connected with a thread of the hub shell. The helical line extends in the axial direction between the opposing sides of the threaded ring and around the circumference of the threaded ring.

A thread groove of a thread is formed in particular by a continuous thread flank or a number of continuous thread grooves of the thread extending along the helical line of a thread. A full revolution is one full circle of the helical line along the circumference of the threaded ring over an angle of 360°. A helical line is a line which extends in the axial direction in a spiral around the circumference of the threaded ring (showing a gradient). Thus, five full revolutions correspond to an angle at circumference of (5*360°=) 1800°. A number of full revolutions of the thread form a number of continuous thread grooves of the thread. In an embodiment, the threaded ring includes a threaded groove that extends two full revolutions about an inner surface of the threaded ring. In another embodiment, the threaded ring includes a threaded groove that extends three full revolutions about an inner surface of the threaded ring. In a further embodiment, the threaded ring includes a threaded groove that extends four full revolutions about an inner surface of the threaded ring.

The threaded ring is in particular provided with a multiple thread and is screwed to a multiple thread of the hub shell.

The hub according to the invention has many advantages. The hub according to the invention in particular allows a lighter weight and a stiffer architecture. A considerable advantage is achieved in that the screwed connection between the hub shell and the hub-side freewheel component is obtained by a thread which only shows a small number of full revolutions and extends along a helical line. It is advantageous for the thread to extend only over a small number of continuous thread grooves along the helical line.

The thread groove extends in particular continuously along the circumference of the threaded ring. Preferably, the thread flank of the continuous thread is not interrupted. However, in an embodiment, cuts, millings or the like may be provided, where the cuts of the interrupted thread groove continue to be disposed along the helical line.

A multiple thread with at least two thread grooves is in particular used.

The hub shell and the hub-side freewheel component are screwed to one another, wherein the hub shell thread and/or the hub-side freewheel component thread are each provided with at least two separate, axially spaced apart thread grooves. This construction enables an increased thread groove gradient compared to a single thread. The gradient angle is larger and thus the axial force effective in the screwed state is lower. Thus the axial pressure exerted on the hub shell by the threaded ring urging into the hub shell is reduced. Due to the increased gradient the axial force is considerably reduced over the prior art. This applies generally, not only for single threads. The entire axial force of the two thread grooves, which must be summed up, is lower than the axially acting force in the case of one single thread groove showing the same pitch. It has been found that in a real construction the acting axial force is noticeably reduced.

In operation the driving torque basically urges the hub-side freewheel component ever farther into the hub shell so that the driving forces result in increasing pressure on the hub shell and within the hub shell. This results in possible local deformation by bending of the prior art hub shell due to the occurring loads. In the prior art this could result in the hub shell breaking in the case of defective or too narrow dimensions. The present invention offers the considerable advantage that the acting axial forces can be reduced. The small number of continuous thread grooves allows to achieve a large thread pitch. The large thread pitch causes transmission of a large part of the forces acting due to the threaded ring on the hub shell in the peripheral direction, in which a high moment of resistance to deformation is present.

For this, in particular the driving force of the hub intended for transmission must be transmitted through the thread of the threaded ring from the freewheel into the hub shell. Accordingly, a skilled person will have strong reservations about using a thread having such a small number of continuous thread grooves, for the high loads. The load on the short continuous thread groove respectively on the thread extending along the helical line with the five full revolutions is high. A skilled person would therefore attempt to distribute the load to a large number of continuous thread grooves, so as to keep the load on each individual thread groove low while at the same time achieving secure retention of the threaded ring in the hub shell.

In practical use it was surprising and unexpected that in the present load case, the driving force can be transmitted safely and non-destructively, through a thread having a low number of continuous thread grooves and a large gradient. A double-pitch (or triple-pitch) or “n”-pitch thread doubles (triples) the gradient angle or multiplies it by “n” while the pitch remains unchanged. Overall the forces acting axially inwardly into the hub shell in the axial direction are considerably lower so that no hub shell deformation or at least noticeably reduced deformation occurs given the same wall thicknesses. The wall thickness may be reduced while safety is concurrently increased. The forces deforming the hub shell are smaller.

Furthermore, self-retention of the thread is low, due to the small number of continuous thread grooves, so that a self-retaining retention cannot be guaranteed in the case of high loads. However, the threaded ring is permanently driven into the hub shell in operation, so that the self-retention of the thread is of secondary importance, which is another advantage for the load. The self-retention of the thread is still sufficient though so that autonomous detaching in a static state need not be feared. Moreover, detaching for maintenance is considerably easier when removing or exchanging, thus unscrewing, the threaded ring.

Ultimately, the invention allows the hub diameter to be reduced compared to conventional hubs. Overall, the invention thus reduces the total weight and aerodynamic drag due to a feasible reduced outer hub diameter while the stability under load increases.

Advantageously, the helical line shows more than two full revolutions (= 2*360°) and in particular more than three full revolutions (=3*360°). Thus, a secure retention of the threaded ring in the hub shell and sufficient centering of the threaded ring in the hub shell can thus be advantageously ensured.

Preferably, the helical line (or the thread groove) shows between two and four full revolutions. Advantageously, this ensures an optimal ratio between the length of the thread flank of the thread groove and the largest possible gradient of the thread, so as to achieve weight saving combined with positive centering and secure retention.

Preferably, the thread extends at least over a considerable portion of the axial width of the threaded ring. Preferably, the thread extends over at least 30%, 50% or even at least 70% or more of the axial width of the threaded ring. Advantageously, using a large portion of the axial width allows to choose a large gradient for the continuous thread groove. The force transmission over the entire width of the threaded ring further minimizes the loads on the threaded ring. Preferably, the functional safety is increased, and the risk of damage from load peaks is minimized.

Advantageously, the axial width of the threaded ring is at least the same as the axial width of the hub-side freewheel component. Advantageously, the width of the threaded ring is oriented at the width of the freewheel component, so as to guarantee a safe force transmission with minimal wear. Advantageously, the width available for the thread is (implicitly) co-determined by the required width of the freewheel component.

Advantageously, the threaded ring shows an axial width at least between in particular 4 mm and 12 mm, preferably 6 mm and 10 mm, and advantageously of 7 mm (+/- 30%). Preferably, this axial width can ensure safe force transmission combined with a low weight.

Preferably, the threaded ring is made of a material having a compression strength, shear strength and/or tensile strength that is greater than a compression strength, shear strength and/or tensile strength of the material of the hub shell. Preferably, the hub shell is formed of a material weighing less than the threaded ring. Preferably, the hub shell consists at least partially or entirely of a light metal alloy such as e.g. aluminum alloy and/or magnesium alloy and/or lightweight materials such as carbon and/or fiber-reinforced plastic.

Particularly preferably, the threads (on the threaded ring and the hub shell) are multiple threads. In advantageous specific embodiments the threaded ring is configured with a multiple external thread and the hub shell, with a multiple internal thread which are screwed to one another when mounted. Particularly preferably, the threaded ring is substantially or nearly entirely or entirely screwed into the hub shell. Alternately, it is conceivable for the threaded ring to show multiple internal threads for screwing onto a matching external thread of the hub shell.

Preferably, the multiple thread shows “n” separate thread grooves. Advantageously, a multiple thread can achieve a smaller pitch than can a single thread. Advantageously, this can enhance the centering of the threaded ring in the hub shell. Moreover, in the case of a multiple thread, a number of separate thread grooves with separate thread flanks is available for force transmission, so as to increase the self-retention by friction, while more thread grooves are available for force transmission.

Preferably, the thread, and in particular at least one separate thread groove (of at least one of the multiple threads and in particular both of the multiple threads) shows a gradient of at least 1.5 mm. When using a double thread, each separate thread groove then shows a gradient of 1.5 mm, and the pitch is 0.75 mm.

Thus, given a gradient that is larger (e.g. 1.5 mm or 2 mm) than in the prior art (e.g. 1 mm) one can still insert a finer thread so as to provide a still better guide for the thread ring in the hub shell. This allows enhanced centering of the freewheel component. Moreover the axial forces are lower due to the changed geometric conditions.

In other preferred embodiments, the gradient of a thread groove of at least one of the multiple threads and preferably both of the multiple threads is at least 1.8 mm. Given a double thread and a gradient of 1.8 mm the pitch is then 0.9 mm. Given a triple thread the pitch is then 0.6 mm. These examples use a particularly fine thread while the axial forces and also the retention are reduced.

In particularly preferred configurations, the thread and in particular at least one thread groove (of at least one of the multiple threads) shows a gradient of at least 2.5 mm or 3.0 mm or 4.0 mm or more. For example when using three thread grooves in the multiple threads, given a gradient of 3.0 mm the pitch is 1.0 mm. This allows to considerably reduce the axial force with the pitch remaining unchanged. Given a width of a threaded ring of 9 mm, each separate thread groove is provided for 3 full revolutions or (continuous) thread grooves, which form one continuous thread flank each. Given a width of a threaded ring of 7 mm, each separate thread groove is provided for 3.5 (continuous) thread grooves, which form one continuous thread flank each, and encircle the threaded ring at an angle of approximately 1260°.

In advantageous configurations, the thread shows a gradient between 1.5 mm and 4.0 mm. A thread gradient of 2 mm (+/-10 %) has shown to be particularly advantageous. Given such a gradient, good centering of the threaded ring through the thread can be guaranteed simultaneously, in addition to force reversal.

Preferably, the gradient of the thread is chosen larger than for a standard thread, such as a metric ISO fine-pitch thread or DIN fine-pitch thread, to divert the forces acting on the threaded ring in the peripheral direction. A diameter of the threaded ring may be for example ca. 34 mm, so that the skilled person would select for the narrow threaded ring, a metric ISO fine-pitch thread of ca. 1 mm. However, a skilled person would have strong reservations about using a thread

having a still larger gradient, which would be outside the standard, as in the present case.

In preferred configurations the multiple threads show 2, 3, 4 or more separate thread grooves (aligned in parallel).

Preferably, each of the engagement components forms an axial toothing and particularly preferably, at least one of the two freewheel components is configured as a toothed disk. It is also possible to configure both of the freewheel components as toothed disks. The two toothed disks may be identical in configuration or their axial widths may differ.

It is possible and preferred for the toothed disks to show a constant, hollow cylindrical inner diameter. Alternately, it is possible for a cross-section of a freewheel component to show a U- or L-shape. Then the engagement components are in particular provided at or formed on the radial leg.

In preferred configurations the freewheel component comprises a non-round outer contour and is non-rotatably and axially displaceably received in a matching non-round inner contour of the threaded ring or the rotor. Such a non-round outer contour of the freewheel component may be polygonal. It is possible and preferred for the non-round outer contour of the freewheel component to be a radial external toothing. Then the non-round inner contour of the threaded ring is in particular a matching or adapted radial internal toothing. These measures ensure non-rotatable engagement between the freewheel component and the threaded ring or rotor.

The biasing device may be provided with a spring device or several separate spring devices. Preferably, the two freewheel components are separately urged toward one another from the outside. Alternately, it is possible to dispose a freewheel component to be immovable in the axial direction and to urge the other of the freewheel components axially against it for biasing the freewheel to the engagement position.

In all the configurations the biasing device may for example comprise one or more coil springs. It is also possible for the biasing device to bias the freewheel in the engagement position by way of magnetic spring forces.

If the freewheel component that is for example configured as a toothed disk has a solid body including a cylindrical through hole the biasing device preferably acts on one of the axial ends while the engagement components are configured on the front face of the other of the axial ends.

In the case of freewheel components comprising a sleeve-like axial body section and a washer at the front face of which the engagement components are formed, the biasing device is preferably urged in the axial direction against the radial leg of the freewheel component.

It is possible for the engagement components of the rotor-side freewheel component to be configured as an end toothing on the rotor. Then the rotor-side freewheel component may be configured integrally with the rotor or be axially fixedly accommodated on the rotor. Then, no axial displacement of the freewheel component relative to the rotor is possible or required in operation.

### BRIEF DESCRIPTION OF THE DRAWINGS

Further advantages and features of the present invention can be taken from the description of exemplary embodiments which will be discussed below with reference to the enclosed figures.

The figures show in:

FIG. 1 a schematic side view of a racing bicycle equipped with a hub according to the invention;

FIG. 2 a schematic side view of a mountain bike equipped with a hub according to the invention;

FIG. 3 a schematic cross-section of a first hub according to the invention;

FIG. 4 an enlarged detail from FIG. 3;

FIG. 5 an exploded view of the toothed disk freewheel of the hub according to FIG. 3;

FIG. 6 another schematic cross-section of a hub of another exemplary embodiment;

FIG. 7 an enlarged perspective view of a threaded ring having four full revolutions of the thread groove.

FIG. 8 an enlarged perspective view of a threaded ring having three full revolutions of the thread groove.

FIG. 9 an enlarged perspective view of a threaded ring having two full revolutions of the thread groove.

### DETAILED DESCRIPTION

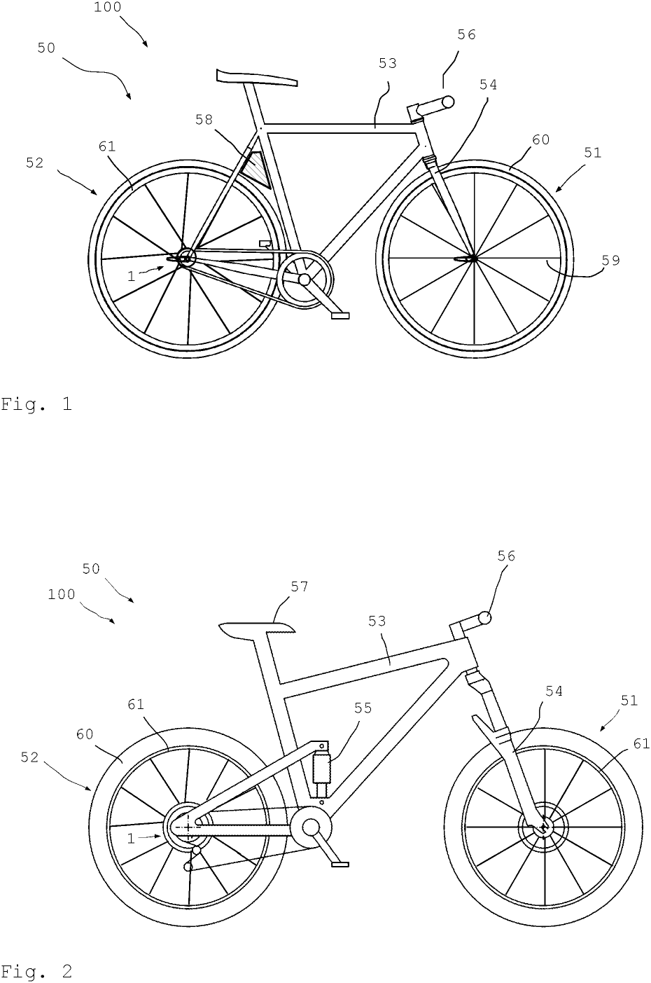

In FIG. 1 a vehicle 100 is illustrated in a schematic side view presently configured as a two-wheeled vehicle 50 and in particular as a racing bicycle. The bicycle 50 is at least partially muscle-powered and may be provided with an electric auxiliary drive.

The racing bicycle is illustrated in a simplistic side view and comprises a front wheel 51, a rear wheel 52 and a frame 53. A handlebar 56 serves as a control and may have different configurations. Apart from a racing handlebar configuration other known configurations are conceivable as well. Beneath the saddle 57 a battery 58 may be provided which is employed in particular for electro-assisted two-wheeled vehicles. Generally speaking, such a battery 58 may be attached to the frame in other places or incorporated into the frame or received elsewhere.

In the bicycle according to FIG. 1 the tire 60 is configured as a tubeless tire and is for example glued onto the rim 61. The rims 61 of the front wheel 51 and the rear wheel 52 are each connected with the hub via spokes 59. The rear wheel 52 is provided with a hub 1 according to the invention as the rear wheel hub.

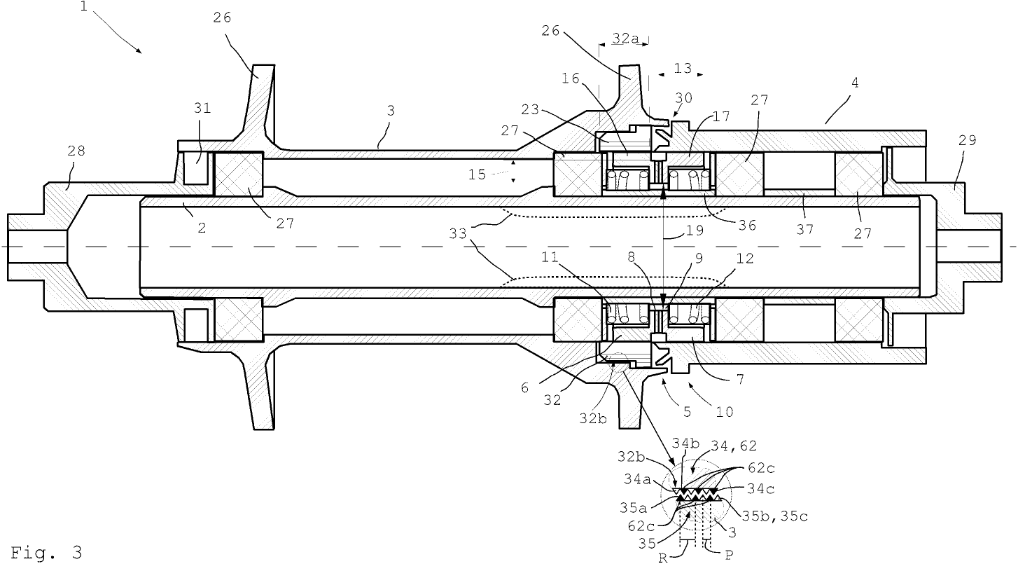

FIG. 2 illustrates a mountain bike as the bicycle 50 in a simplistic side view comprising a front wheel 51, a rear wheel 52, a frame 53, a sprung front fork 54 and a rear wheel damper 55. In this exemplary embodiment, disk brakes are provided. The rear wheel 52 is also provided with a hub 1 according to the invention.

FIG. 3 shows a simplistic cross-section of an inventive hub 1 for a bicycle 50 according to FIG. 1 or FIG. 2.

The hub according to the invention is provided with a hub axle 2 presently configured hollow and a hub shell 3 presently configured one-piece which comprises two hub flanges 26 for fastening the spokes. In other configurations the hub shell 2 may be configured multipart and for example be provided with a separate hub sleeve to which separate hub flanges 26 are fastened. It is also possible to configure the hub as a “straight pull hub” where no conventional hub flanges are provided.

The rotor 4 serves to receive at least one sprocket and in particular to receive a sprocket cluster having multiple sprockets. Selecting a corresponding sprocket allows to vary the driving gear ratio as desired.

The hub shell is supported in the two axial end regions of the hub shell relative to the hub axle 2 through a roller bearing 27. The rotor is likewise supported relative to the hub axle 2 by means of two bearings 27.

A freewheel 5 is provided here which is configured as a toothed disk freewheel. The freewheel serves to transmit the driving torque to the hub shell while for example in downhill rides or the like a decoupling of the rotational movements of the hub shell and the rotor may occur.

In the illustrated exemplary embodiment the freewheel 5 is provided with two freewheel components 6 and 7 each provided with axial engagement components 8, 9 which in the engagement position 10 illustrated in FIG. 3 are engaged with one another.

In the exemplary embodiment the two freewheel components 6, 7 are each configured as a toothed disk 16 or 17, preferably showing identical architecture. The engagement components 8 and 9 each form an axial toothing 18 (cf. FIG. 5) on the front faces of the freewheel components 6, 7 respectively toothed disks 16, 17.

The cross-section of each of the toothed disks is generally about U-shaped, the geometry of the toothed disks 16 and 17 resulting from combining a perforated disk or washer and a sleeve. The axial toothing 18 is provided at the axial front face of the perforated disk.

It is also possible to configure the toothed disks solid and provided with an inner hollow cylindrical aperture. These toothed disks have engagement components (in particular in the shape of teeth) configured on one front face and on the other front face a biasing device 11 or 12 acts for biasing the two freewheel components 6, 7 in the engagement position 10.

The freewheel component 6 configured as a toothed disk 16 is accommodated in the hub component 23 configured as a threaded ring 32 to be axially displaceable and non-rotatable. To this end the toothed disk 16 comprises an external toothing engaging in a corresponding internal toothing of the threaded ring 32 so as to allow axial movement while prohibiting rotational movement of the toothed disk 16 relative to the threaded ring 32.

One advantage of the separate threaded ring 32 is that the threaded ring 32 is made of a harder and more robust material than the hub shell 3. Since the threaded ring 32 shows a relatively small volume the total weight of the hub is only slightly increased while the service life of the hub is clearly extended.

The radially outside surface of the threaded ring 32 is provided with a multiple thread 34, presently with two separate, axially spaced apart thread grooves 34a and 34b as the enlarged detail shows. Each separate thread groove 34a, 34b is provided with three continuous thread grooves 34c and extends between the endpoints 62a, 62b along a helical line 62 (not shown) having three full revolutions 62c (wraps) around the threaded ring. The multiple thread 34 of the threaded ring 32 is screwed to a matching, multiple internal thread 35 in the hub shell 3, showing separate thread grooves 35a, 35b, each with three continuous thread grooves 35c. The thread 35 is likewise provided with two continuous thread grooves 35c showing three full revolutions each. The multiple internal thread 35 comprises two separate thread grooves 35a and 35b.

The gradient R of the thread grooves of the threads 34 and 35 in this exemplary embodiment is 2.0 mm (or 3.0 mm), while the pitch P is 1.0 mm (or 1.5 mm) each. This means that the same pitch “P” shows double the gradient “R” such that the axial forces exerted on the hub shell by the threaded ring in the axial direction are considerably lower than in the prior art where the threaded ring was screwed into the hub shell by a single thread.

The multiplicity and the helical line 62 (not shown) predetermine a low number of continuous thread grooves 34c with a low number of full revolutions 62c. Basically, this also reduces the retention of the thread 34. However, reduced retention is advantageous since in operation the threaded ring 32 keeps driving into the hub shell 3 such that automatic detachment is excluded in this respect. This thread 34 extends over more than 50% of the width 32a of the threaded ring 32.

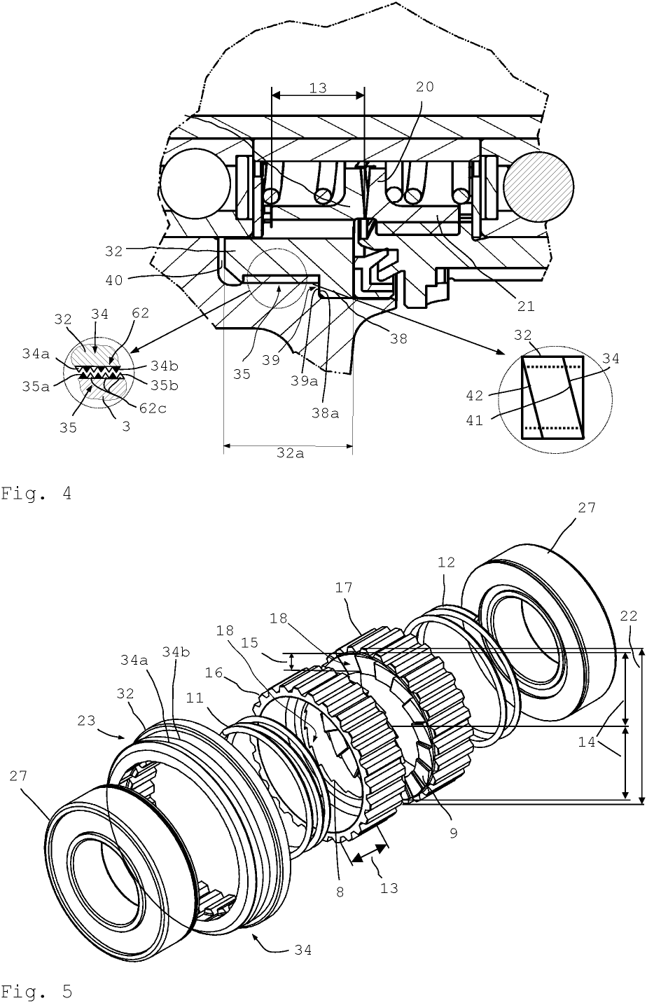

According to the FIGS. 3 and 4 the bearing 27 for supporting the hub shell is radially partially surrounded by the threaded ring 32 on the rotor side. A direct radial contact is not required and is as a rule not present. The threaded ring 32 in particular does not provide a bearing seat. The bearing seat (with correspondingly lower tolerances) is configured in the hub shell 3. It is as a rule provided with a force fit into which the bearing 27 is pressed.

The other of the freewheel components 7 in the present exemplary embodiment is configured as a toothed disk 17 and also comprises a non-round outer contour and in particular an external toothing which is disposed in a corresponding internal toothing of the rotor 4 to be non-rotatable but axially displaceable.

In all the configurations the rotor and the hub shell are disposed fixedly spaced apart in the axial direction in (normal) operation.

Each of the two toothed disks 16, 17 are urged toward one another in the axial direction by means of a biasing device 11 or 12 configured as a coil spring to have the axial toothings 18 of the two toothed disks engage with one another. In this way a torque transmission from the rotor to the hub shell 3 is enabled in the driving direction while in the reversed rotational direction the teeth of the toothed disks 8, 9 are urged away from one another against the force of the biasing devices 11, 12, gliding past one another on their tooth flanks.

For sealing, a seal 30 is provided between the rotor 4 and the hub shell 3 which can presently comprise a contactless labyrinth seal and/or a contacting elastomeric seal to keep moisture and dust and the like away from the freewheel 5.

One of the ends is provided with an adapter ring 28 and the other of the ends with an adapter ring 29 which are pushed onto the hub axle 2 and which at their extreme ends comprise regions suitable to be pushed into the dropouts of a bicycle fork or a bicycle frame. A quick release not illustrated in FIG. 3 may for example serve for fastening. It is likewise possible to use a through axle for fastening, wherein the adapter rings 28 and 29 are as a rule not required or not in this shape.

The adapter ring 28 presently comprises a double-flange seal 31 acting as a double labyrinth seal and showing high efficiency. The adapter ring 29 may be configured in analogy and be provided with a double-flange seal.

The bearings 27 used are preferably commercially available roller bearings provided with an outer ring, an inner ring and rolling members disposed in-between. The rolling members are preferably retained by a holding device such as a rolling member cage or the like. Particularly preferably, the axial ends of the roller bearings show seals for protecting the interior of the roller bearing. The seals may be elastomeric seals. The bearings used are preferably deep-groove ball bearings.

A clear inner diameter of the freewheel components 6, 7 is in particular not larger than twice or three times or four times the axial width 13 of the toothed disk 16. This ensures a secure seat of the toothed disk 16 in the threaded ring 32 and prevents possible tilting of the toothed disk 16 in moving back and forth. This will further increase the reliability of the toothed disk freewheel.

For reinforcement a radial bulge 33 may be provided as is presently illustrated in broken lines. The bulge 33 may be configured inwardly at the hub axle 2. It is also possible to provide the bulge 33 radially outwardly.

The clamping forces in the frame are dissipated by the inner rings of the bearings 27, the sleeves 36 and 37 and by a part of the hub axle 2 into which the clamping force is introduced and outlet through radial bulges on the bearings 27 for supporting the hub shell 3. The clamping forces are outlet at the outwardly ends through the adapter rings 28 and 29.

In the FIGS. 4 and 5 the toothed disk freewheel is illustrated in an enlarged cross-section or in an enlarged, exploded view for better illustration of the details.

FIG. 4 shows the region of the threaded ring 32 in an enlarged illustration. Additionally and again enlarged, a detail showing the multiple threads 34, 35 in the threaded ring 32 and the hub shell 3 is illustrated. By way of their thread grooves 34a and 34b, the two multiple threads 34, 35 engage the thread grooves 35a and 35b in the hub shell to securely receive the threaded ring 32 in the hub shell. Presently, the thread 34 with two thread grooves 34a, 34b extends over a considerable portion of the width 32a of the threaded ring 32, along a helical line 62 showing three full revolutions 62c each, which engage in the continuous thread grooves 35c of the thread 35 of the hub shell 3. The multiple threads 34, 35 provide for reliable guiding and secure retention of the threaded ring 32 in the hub shell 3.

In the lower right corner of FIG. 4 a possible embodiment of the threaded ring 32 is shown, where the thread 34 only comprises two full revolutions 41 and 42.

As can be clearly seen in FIG. 4 the threaded ring shows at its axially outwardly end a slightly enlarged (and here) circumferential flange 38 at the axially inwardly end of which a stopper 38a is formed which rests against a corresponding stopper 39a of a radial shoulder 39 in the hub shell 3. This configuration results in a (narrower) gap 40 remaining at the inner axial end of the threaded ring between the inner axial end of the threaded ring 32 and the body of the hub shell 3. This configuration again contributes to limiting the axial forces acting on the hub shell.

FIG. 5 is an exploded view, wherein the outer radius 14 of the axial toothings 18 is not larger than double the axial width 13 of the toothed disks 16, 17. The size of the axial width 13 of the toothed disks 16, 17 is at least 30 % or 40 % or half the outer radius 14 of the axial toothings 8 respectively 9.

FIG. 5 shows two simplistic thread grooves 34a and 34b on the outer surface of the threaded ring 32, which combined form a multiple thread 34 with two separate thread grooves 34a, 34b, each with three continuous thread grooves 34c.

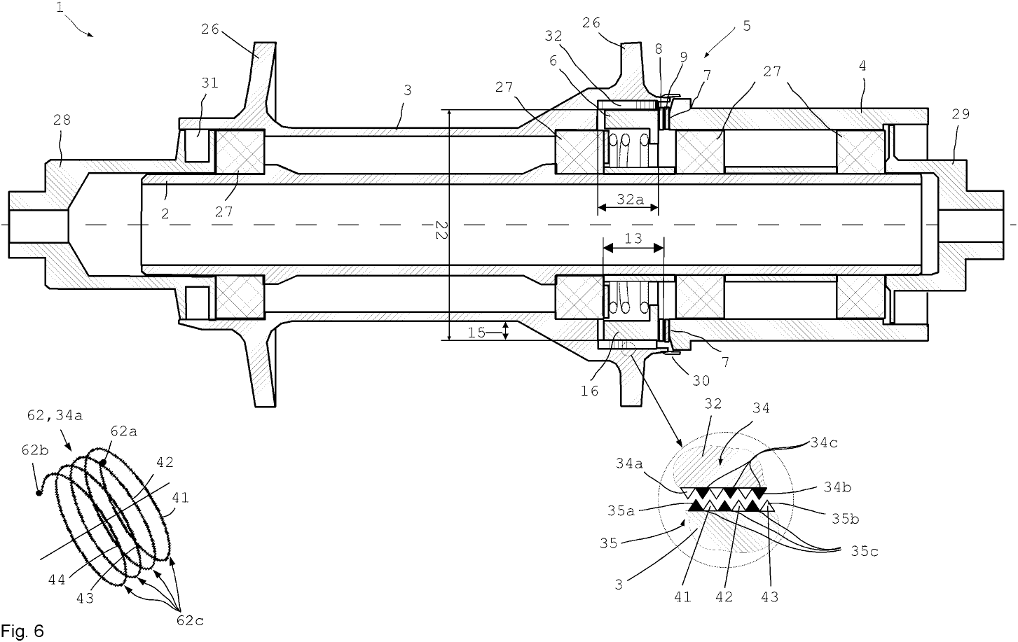

FIG. 6 shows another exemplary embodiment of a hub 1 according to the invention, which is configured substantially the same as is the hub according to the invention according to FIG. 3. Therefore, like or similar parts are provided with the same reference numerals.

The hub 1 in the exemplary embodiment according to FIG. 6 is provided with a hub axle 2 and a hub shell 3 equipped with hub flanges 26. The hub shell 3 is supported rotatably relative to the hub axle 2 through two bearings 27. The rotor is likewise rotatably supported relative to the hub axle by means of two bearings 27.

Between the hub shell 3 and the rotor 4 a freewheel 5 is provided which in turn comprises freewheel components 6 and 7. A contactless and/or contacting sealing may be provided between the rotor 4 and the hub shell 3.

In this exemplary embodiment the freewheel components 6 and 7 are not configured identical but differently. While the freewheel component 6 is configured as a toothed disk 16, the freewheel component 7 is configured as an end toothing at (in particular integrally with) one axial end of the rotor. In this way the axial end of the rotor 4 with the axial toothing 18 provided thereat is in engagement with the axial toothing 18 of the toothed disk 16.

The toothed disk 16 is biased in the axial direction toward the rotor 4 by a biasing device 11 presently configured as a coil spring such that the teeth of the axial toothings 18 are as a rule engaged with one another.

In the exemplary embodiment the bearings 27 provided to support the hub shell 3 adjacent to the toothed disk 16 are for example inserted by means of force fit.

In FIG. 3, a threaded ring 32 for receiving the toothed disk 16 is equipped with a multiple external thread 34 with two separate thread grooves 34a, 34b extending along a helical line 62 with three full revolutions 62c, which is screwed with a corresponding multiple internal thread 35 in the hub shell 3.

The enlarged details beneath FIG. 6 schematically show the region of the intermeshing multiple threads 34 and 35, wherein for the sake of simplicity two thread grooves are indicated at the threads 34 and 35. Again, the threads 34, 35 extend continuously, that is, uninterrupted, along a helical line 62 with three full revolutions 62c, around the outside surface of the threaded ring 32.

For better illustration, the threaded ring 32 with the one single helical line 62 and a separate helical line 62 (presently) showing four full revolutions 62c and the endpoints 62a, 62b, are once again illustrated separately in the lower left region of the FIG. 6, for better understanding. The first revolution 41, the second full revolution 42, the third full revolution 43 and the fourth full revolution 44 are indicated.

Again, the gradient of each of the thread grooves 34a, 34b and 35a, 35b, is twice that of a single thread, so that the forces acting on the threaded ring are largely transmitted in the peripheral direction of the threaded ring 32 into the hub shell 3, and wherein the moment of resistance of the hub shell 3 to torsion is larger than that to bending. However, due to the separate thread grooves 34a, 34b, the pitch of the thread 34 remains as low as that of a single thread. This leads to decreased axial loads acting on the hub shell 3 such that the wall thicknesses of the hub shell may be reduced. This allows to reduce the total weight and it is also possible to reduce air drag since for example the cross-sectional area may be reduced.

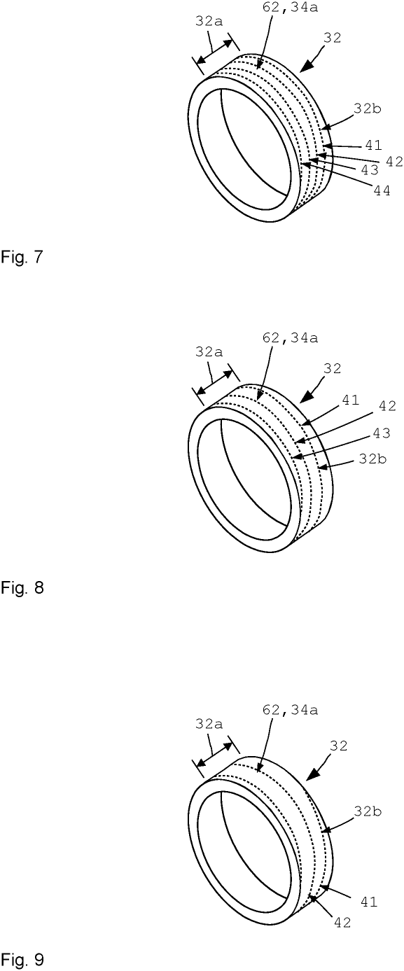

FIG. 7 shows an embodiment of the threaded ring 32 comprising four full revolutions 41, 42, 43 and 44 of the thread groove 34a. Specifically, the threaded ring 32 is provided with a thread 34 with the thread groove 34a. The thread groove 34a extends along a helical line 62 extending in the axial direction around an circumference 32b of the threaded ring 32. The helical line 62 shows less than five full revolutions 62c of the thread grove 34a.

FIG. 8 shows another embodiment of the threaded ring similar to that of FIG. 7. In this embodiment the threaded ring 32 comprises three full revolutions 41, 42 and 43 of the thread groove.

FIG. 9 shows a further embodiment of the threaded ring 32 comprising two full revolutions 41 and 42 of the thread groove.

On the whole the invention provides an advantageous hub 1 which provides a lower weight combined with increased rigidity and enhanced durability.

Basically, the thread of the threaded ring assumes three functions:
transmitting the forces into the hub shell for driving,
attaching the threaded ring in the hub shell,
centering the freewheel component for accurate function.

In the present invention, the gradient of the thread is increased on the narrow threaded ring of the hub shell 3 compared to the prior art, so that a larger portion of the axial force acting on the threaded ring 32 and the hub shell 3, is derived in the peripheral direction of the hub shell 3, in which the moment of resistance to deformation is larger than in its axial direction, so that smaller wall thicknesses are feasible given large thread gradients.

Starting out from the known prior art, a skilled person will use for a screwed connection, a (metric ISO) standard/fine-pitch thread, to ensure safe function of the screwed connection. Basically, however, due to the narrow threaded ring 32 in conjunction with the centering function of the thread 34, 35, the skilled person would tend to use a fine-pitch thread showing a low gradient, so as to provide a thread flank with a large surface, given an appropriate length of thread engagement.

To reduce the weight respectively the wall thickness of the hub 1, the skilled person might reduce the gradient further, so as to (still) further reduce the width of the threaded ring. Alternately, he might reduce the wall thickness of the threaded ring 32, by matching the material used.

In any case, a skilled person would have strong reservations about providing the narrow threaded ring 32 with a thread 34, 35 showing a clearly larger gradient (in particular larger than for a standard thread with a regular gradient), since this would no longer allow to ensure safety of function of the screwed connection, and in particular sufficient length of thread engagement, thus securing retention of the threaded ring 32 in the hub shell 3.

In the present case this is possible only since, due to the dynamic load and deformation of the hub shell 3, in particular by means of a thread 34 having a very high gradient (in particular beyond the normalized standards), the narrow threaded ring 32 is permanently driven into the hub shell 3 where it is securely retained. Moreover, a multiple thread 34a, 34b increases this effect by way of increased friction, and additionally allows improved centering.

List of reference numerals

| | |
|---|---|
| 1 hub | 28 adapter ring |
| 2 hub axle | 29 adapter ring |
| 3 hub shell | 30 seal |
| 4 rotor | 31 double flange seal |
| 5 freewheel | 32 hub component, threaded ring |
| 6 freewheel component | |
| 7 freewheel component | 32a width of 32 |
| 8 engagement component | 33 bulge |
| 9 engagement component | |
| 10 engagement position | 34 thread |
| 11 biasing device | 34a thread groove |
| 12 biasing device | 34b thread groove |
| 13 axial width | 34c continuous thread groove of 34a, 34b |
| 14 outer radius | |
| 15 radial extension | 35 thread |
| 16 toothed disk | 35a separate thread groove |
| 17 toothed disk | 35b separate thread groove |
| 18 axial toothing | 35c continuous thread groove of 35a, 35b |
| 19 inner diameter | |
| 20 radial leg | 36 sleeve |
| 21 axial leg | 37 sleeve |
| 22 outer diameter | 38 flange |
| 23 hub component | 38a stopper |
| 24 hub component | 39 shoulder |
| 25 outer radius | 39a stopper |
| 26 hub flange | 40 gap |
| 27 bearing | 41 first revolution |

42 second revolution
43 third revolution
44 fourth revolution
50 bicycle
51 front wheel
52 rear wheel
53 frame
54 fork
55 rear wheel damper
56 handlebar
57 saddle
58 battery
59 spoke
60 tire
61 rim
62 helical line
62a first endpoint
62b second endpoint
62c full revolution
100 vehicle

What is claimed is:

1. A hub for at least partially muscle-powered vehicles and in particular two-wheeled vehicles having a hub axle nd a hub shell and a rotor and a freewheel comprising a pair of interacting freewheel components namely, a hub-side freewheel component and a rotor-side freewheel component,
wherein the freewheel components each comprise axial engagement components for intermeshing with one another and are biased in the engagement position through at least one biasing device,wherein the hub-side freewheel component is axially displaceably received in a threaded ring and non-rotatably coupled with the hub shell, and wherein the rotor-side freewheel component is non-rotatably provided at the rotor for transmitting rotational movement from the rotor to the hub shell in the engagement position of the two freewheel components,
wherein the threaded ring is provided with at least one thread with at least one thread groove, wherein the thread groove extends along a helical line extending in the axial direction around an outer circumference of the threaded ring, and wherein the helical line shows less than five full revolutions around the circumference of the threaded ring, and wherein the thread is screw-connected with a thread of the hub shell.

2. The hub according to claim 1 , wherein the helical line comprises at least more than two full revolutions of the thread groove.

3. The hub according to claim 1 , wherein the helical line comprises between two and four full revolutions of the thread groove.

4. The hub according to claim 1 , wherein the thread groove extends continuously along the circumference of the threaded ring.

5. The hub according to claim 1, wherein the thread extends over more than 50% of the axial width of the threaded ring.

6. The hub according to claim 1, wherein the thread extends over the entire axial width of the threaded ring.

7. The hub according to claim 1, wherein the axial width of the threaded ring is at least the same size as the axial width of the hub-side freewheel component.

8. The hub according to claim 1 , wherein the thread is a multiple thread which is screw-connected with a multiple thread of the hub shell.

9. The hub according to claim 8, wherein the threaded ring consists of a stronger material than does the hub shell.

10. The hub according to claim 8 , wherein multiple outer threads are formed on the threaded ring and multiple inner threads, on the hub shell, which are screwed to one another when mounted.

11. The hub according to claim 1, wherein a thread groove of at least one of the threads shows a gradient of between 1.5 mm and 4.0 mm.

12. The hub according to claim 11 , wherein a thread groove shows a gradient of 2 mm.

13. The hub according to claim 10 , wherein the multiple outer and inner threads include two, three or more separate thread grooves aligned in parallel.

14. The hub according to claim 1 , wherein the engagement components form one axial toothing each, and wherein at least one of the two freewheel components is configured as a toothed disk.

15. The hub according to claim 1 , wherein a cross-section of the freewheel component is configured U- or L-shaped, and wherein the radial leg is provided with the engagement components.

16. The hub according to claim 1 , wherein the freewheel component has a non-round outer contour and is received in a corresponding non-round inner contour of the threaded ring or of the rotor to be non-rotatable and axially displaceable.

17. The hub according to claim 1 , wherein the biasing device is at least partially disposed in the interior of the freewheel component, and wherein the biasing device presses against the radial leg of the freewheel component in the axial direction, and wherein the engagement components of the rotor-side freewheel component is configured as an end toothing at the rotor.

18. The hub according to claim 1 , wherein at least one freewheel component and the threaded ring consists of steel and the hub shell consists at least in part of at least one lightweight material such as light metal or a fibrous composite material.
